(19) United States
(12) Patent Application Publication
(10) Pub. No.: US 2015/0269237 A1
(43) Pub. Date: Sep. 24, 2015

(54) Disaster Recovery of Converged Infrastructure Platforms

(71) Applicants: Andrew William Ries, Columbia, SC (US); Ashutosh Vyas, San Francisco, CA (US); Andrew Russell Cress, Lexington, SC (US)

(72) Inventors: Andrew William Ries, Columbia, SC (US); Ashutosh Vyas, San Francisco, CA (US); Andrew Russell Cress, Lexington, SC (US)

(73) Assignee: UNITRENDS, INC., Columbia, SC (US)

(21) Appl. No.: 14/300,373

(22) Filed: Jun. 10, 2014

Related U.S. Application Data
(60) Provisional application No. 61/968,137, filed on Mar. 20, 2014.

(51) Int. Cl. G06F 17/30; G06F 11/14

(52) U.S. Cl. CPC G06F 17/30575; G06F 11/1412; G06F 2201/80

(57) ABSTRACT

A method, computer and system for the backup and recovery of a converged infrastructure computer system is provided. The method and system provides backup and recovery of the data and applications on the servers themselves, but further provides backup and recovery of the configuration and mapping information of the converged infrastructure computer system itself.

### CROSS REFERENCE TO RELATED APPLICATION

The present application claims the benefit of U.S. Provisional Application Ser. No. 61/968,137 entitled “Disaster Recovery of Converged Infrastructure Platforms” and filed Mar. 20, 2014 which is incorporated herein by reference in its entirety.

### FIELD OF THE INVENTION

The present invention relates generally to disaster recovery of computer platforms and more specifically to backing up and restoring converged infrastructure computer platforms that include one or more servers, a network switch and storage.

### BACKGROUND

It is common to implement some level of disaster recovery for a computer or computer system. A disaster recovery plan includes one or more techniques for backing up part or all of the data, software, and information required to operate a computer or a computer system. Typically, the more critical the application executed by the computer, the higher the level of disaster recovery implemented by the computer.

Computer backup systems may suitably provide functionality to backup and restore individual servers, both at the physical and virtual level to provide the ability to recover the server in the event of a disaster that renders the server unusable or unreachable. These backups are often referred to as bare-metal backups because a new server can be restored from a blank or “bare metal” state back to the state of the original server including its operating system and applications.

When one or more computer servers are needed to support software functions, the computer servers may be implemented using a converged infrastructure computer solution that is provided by a number of computer hardware vendors. A converged infrastructure computer solution includes an integrated chassis with one or more computer servers, one or more network switches, and disk storage. In addition to providing the physical components in the same chassis, the solution also provides an integrated management component that manages the physical and logical configurations of the components in the chassis. Examples of such converged infrastructure platforms include Cisco's Unified Computing System (UCS), Dell's PowerEdge VRTX, and IBM's PureSystems.

A number of backup products provide disaster recovery solutions for failed servers however none provide a fully automated disaster recovery solution at the converged infrastructure computer platform level.

### SUMMARY

Among its several aspects, the present invention seeks to overcome or ameliorate at least one of the disadvantages of the prior art, or to provide a useful alternative.

In accordance with the teachings of the present invention, a backup and restore appliance is provided for backing up and restoring converged infrastructure computer platforms. The appliance includes a computer or computer server in communication with one or more converged infrastructure computer platforms.

Among its several aspects, the present invention recognizes there is an advantage to performing both a backup and restore function for a converged infrastructure computer platform with minimum human input. To accomplish this, the backup appliance is able to automatically capture and restore the converged infrastructure configuration and mapping information of the converged infrastructure computer platform. The human input can be provided by the normal computer support personnel responsible for maintaining the converged infrastructure computer platform. No specialized technicians are required.

Among its several aspects, the present invention recognizes there is an advantage to performing a backup of a converged infrastructure computer platform and a restoring of a single computer blade located within the converged infrastructure computer platform with minimum human input.

In accordance with an embodiment of the present invention, there is provided a computer implemented method performed by a backup appliance for backing up and restoring a first converged infrastructure computer platform. The method comprising: receiving and storing converged infrastructure configuration and mapping information for the first converged infrastructure computer platform where the converged infrastructure configuration and mapping information define a configuration of the first converged infrastructure computer system at a particular point in time; receiving and storing backup information from the first converged infrastructure computer platform; and associating the configuration with the backup information received from the first converged infrastructure computer platform.

In accordance with another embodiment of the present invention, there is provided a computer system comprising: a first converged infrastructure computer system; a second converged infrastructure computer system; and a backup computer including a processor in communication with the first and second converged infrastructure computer systems, the backup computer further including computer instructions that when executed by the processor cause the processor to perform the following steps: receiving and storing converged infrastructure configuration and mapping information for the first converged infrastructure computer platform where the converged infrastructure configuration and mapping information define a configuration of the first converged infrastructure computer system at a particular point in time; receiving and storing backup information from the first converged infrastructure computer platform; associating the configuration with the backup information received from the first converged infrastructure computer platform; restoring the converged infrastructure configuration and mapping information to a second converged infrastructure computer system; and restoring, after restoring the converged infrastructure configuration and mapping information, the backup information to the second converged infrastructure computer system.

A more complete understanding of the present invention, as well as further features and advantages of the invention, will be apparent from the following Detailed Description and the accompanying Drawings.

### BRIEF DESCRIPTION OF THE DRAWINGS

The present invention may take form in various components and arrangement of components and in various methods. The drawings are only for purposes of illustrating example embodiments and alternatives and are not to be construed as limiting the invention. The drawings are not necessarily drawn to scale. Throughout the drawings, like element numbers are used to describe the same parts throughout the various drawings, figures and charts.

FIG. 1 is a high-level flowchart illustrating a method of recovery of a converged infrastructure system when the hardware is replaced or the system otherwise needs to be restored from a “factory imaged” state.

FIG. 2 is a high-level block diagram of an example converged infrastructure system and its relationship to a backup appliance.

FIG. 3 is a high-level block diagram of an embodiment that allows the restoration of a converged infrastructure system in a geographically remote location.

FIG. 4 is provided a high-level block diagram illustrating selected computer hardware and software components of the backup appliance.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

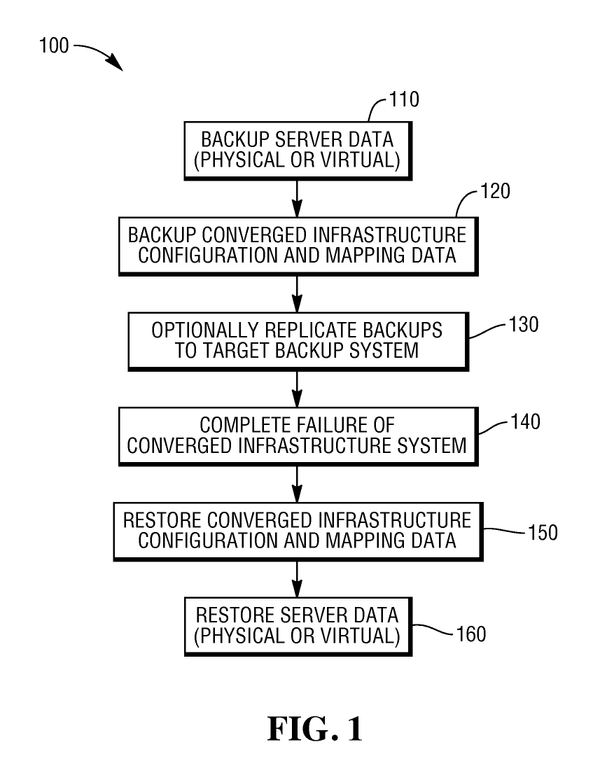

Turning now to FIG. 1, there is provided a flowchart illustrating a method 100 of recovery of a converged infrastructure system when the hardware is replaced or the system otherwise needs to be restored from a “factory imaged” state. At step 110, server data is backed up by a backup system, either as a physical “bare metal” backup, or, if the system is running a virtualization operating environment such as VMWare ESX Server, the virtual machines operating on the server are backed up, as someone skilled in the art would understand.

At step 120, the step of backing up the converged infrastructure configuration and mapping data is introduced. In this step, the backup system obtains all information that the converged infrastructure system uses to specify profiles associated with the servers in the system. The backup system can store this information as a point in time backup that can be restored to the same or different converged infrastructure system in the future.

At step 130, the server and converged infrastructure backups can optionally be replicated to a second backup system at a remote site. By replicating the data to a remote system, an alternate converged infrastructure system at a geographically remote site can be restored to the state of the original system in the event of a disaster which destroys both the original converged infrastructure system and the original backup system at the original site. In some cases, a disaster may not destroy the original system but may instead prevent communications with the original system. The original system may suitably be replicate to a remote site.

At step 140, the original converged infrastructure system fails either from an external disaster event, or an internal software or hardware event which causes its data and configuration information to be lost.

At step 150, the converged infrastructure configuration and mapping data is restored to either a new converged infrastructure hardware platform or the same platform starting from a factory reimaged state. This configuration restore allows the subsequent server restores to have all of the configuration information needed to put the servers into full service after the disaster recovery with little or no human intervention.

At step 160, the server data is restored from the backup system, either as a physical “bare metal” restore, or, if the system is running a virtualization operating environment such as VMWare ESX Server, the virtual machines operating on the server are restored, as someone skilled in the art would understand. At this point, the restored system resumes the operation of the original converged infrastructure computer system.

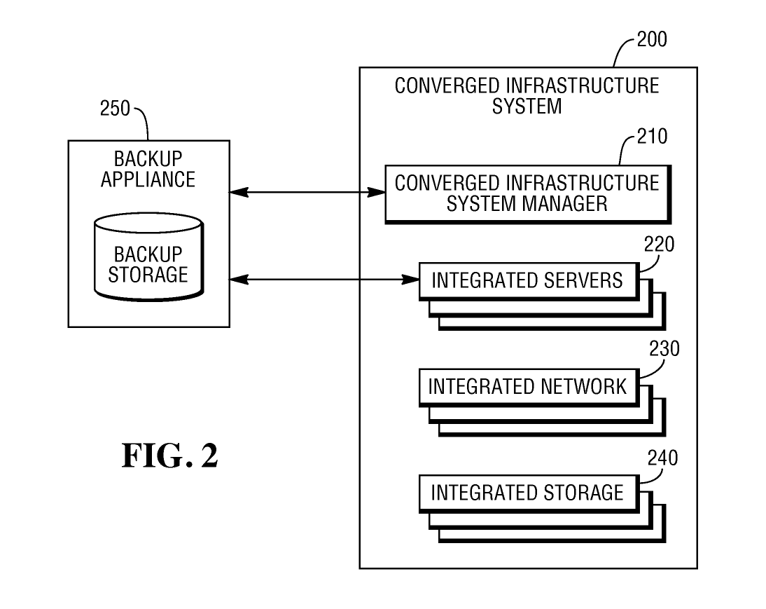

With reference to FIG. 2, there is provided a block diagram of an embodiment 200 of a converged infrastructure computer system and its relationship to a backup appliance 250. The embodiment 200 is a converged infrastructure computer system containing an internal system manager 210, integrated servers 220, integrated networks 230, and integrated storages 240. It is understood that other embodiments may not contain all of these components.

In this embodiment, the backup system 250 communicates with the converged infrastructure system over a communication interface, which is typically, but not limited to, a networking interface. The backup appliance 250 can obtain configuration and mapping information from the converged infrastructure system manager 210, which may include, but is not limited to: firmware versions of the server; network information for the server ports (for example mac and IP addresses); server memory size; server storage (disk) sizes; and power management policies. The Cisco UCS converged infrastructure system is an example of one such embodiment that captures this configuration and mapping information in “service profiles.” In FIG. 2, a communication interface between the backup system 250 and the integrated servers 220 is used for backing up the servers themselves either physically, or in the case of a virtualization operating environment, the virtual machines on the server.

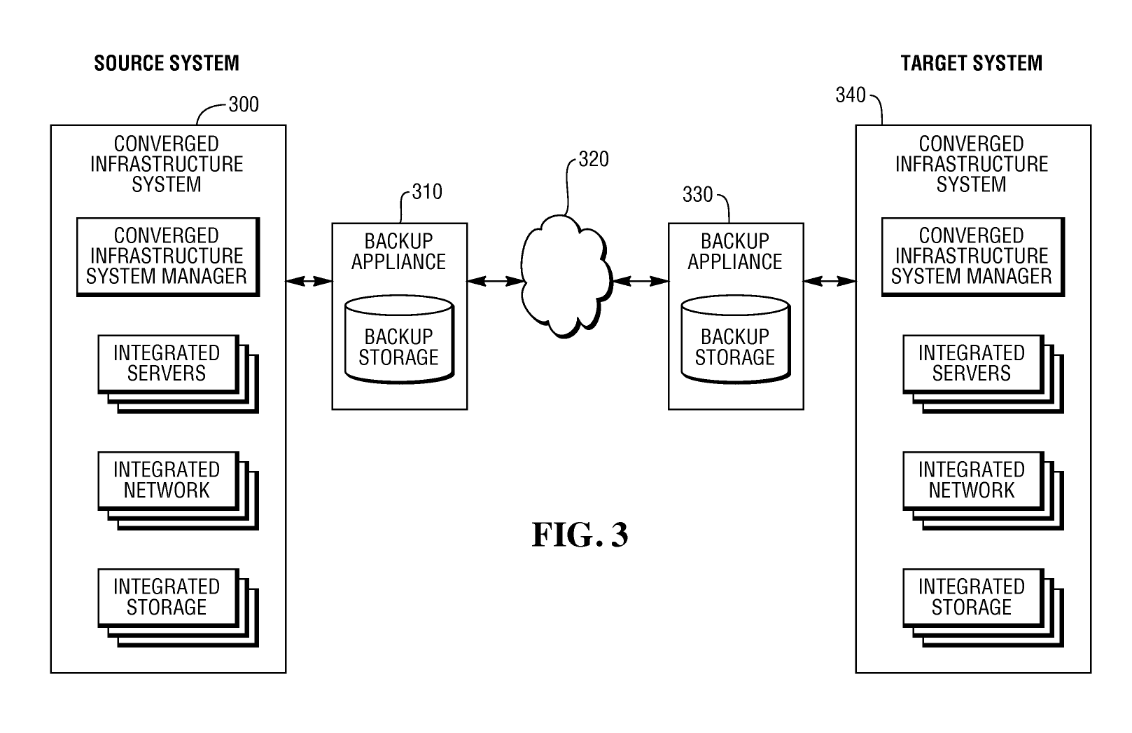

With reference to FIG. 3, there is provided a block diagram of an embodiment that allows the restoration of a converged infrastructure system in a geographically remote location. In this embodiment, the backup system 310 obtains the server and converged infrastructure configuration and mapping data backups from converged infrastructure system 300. The backup system 310 then replicates the backup data over a network 320 to an alternate backup system 330 in a geographically remote location. The alternate backup system 330 can then restore the converged infrastructure configuration and mapping backups, as well as the server backups, to an alternate converged infrastructure system 340. The network 320 may suitably include a private or public network or a combination thereof that connects the backup system 310 to a geographically remote location where the alternate backup system 330 is located. The public network may suitably include the Internet.

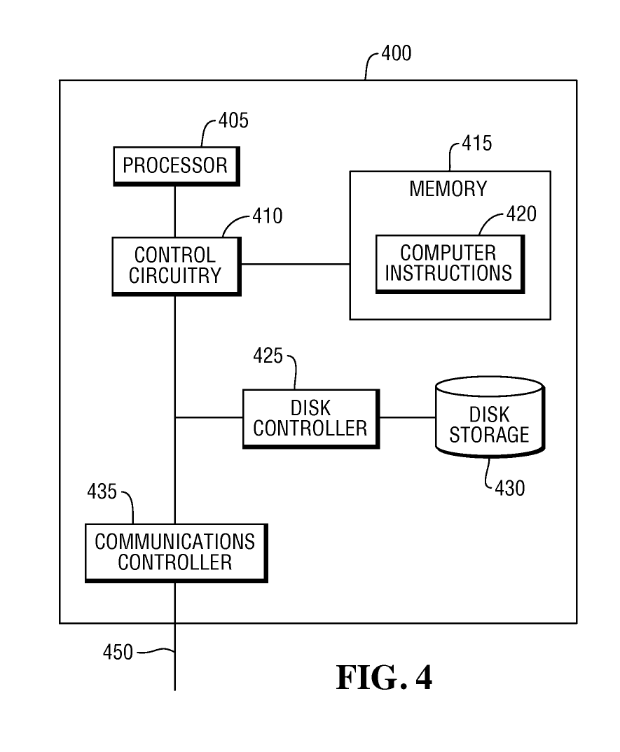

Now with reference to FIG. 4, there is provided a high-level block diagram illustrating selected computer hardware and software components of the backup appliance. The backup appliance includes a computer 400. The computer 400 includes a processor 405, control circuitry 410, a memory 415, a disk controller 425, a disk storage 430, a communications controller 435 and a network 450.

The control circuitry 410 includes components that allow the processor 405 to communicate with the memory 415 to read and write to the contents of the memory 415 and to communicate with the communications controller 435 and to communicate with the disk controller 425.

The memory 415 uses non-transitory storage devices including both volatile and non-volatile memory. The non-volatile memory may suitably include flash memory, other types of solid state electronic memory and rotating storage devices, such as disk drives or the like. Non-volatile memory retains stored information after power is removed from the memory and until power is restored. Computer instructions 420 stored in the memory 415 are executed by the processor 405 and cause the processor 405 to control the devices, controllers and peripherals attached to or part of the computer 400 to perform functions associated with backing up and restoring a converged infrastructure computer platform.

The communications controller 435 sends and receives information using a digital computer network 450 to one or more converged infrastructure computer platforms. In some embodiments, the computer 400 sends information to a computer or another backup appliance to allow remote recovery.

The disk storage 430 includes a plurality of disk drives. In some embodiments, some or all of the disk drives are solid state disk drives where the rotating disks are replaced by solid state memory devices.

Although the present invention has been described with particular reference to certain preferred embodiments thereof, variations and modifications of the present invention can be effected within the spirit and scope of the following claims.

What is claimed is:

1. A computer implemented method performed by a backup appliance for backing up and restoring a first converged infrastructure computer platform, the method comprising:
receiving and storing converged infrastructure configuration and mapping information for the first converged infrastructure computer platform where the converged infrastructure configuration and mapping information define a configuration of the first converged infrastructure computer system at a particular point in time;
receiving and storing backup information from the first converged infrastructure computer platform; and
associating the configuration with the backup information received from the first converged infrastructure computer platform.

2. The method of claim 1 further comprising:
restoring the converged infrastructure configuration and mapping information to a second converged infrastructure computer system; and
restoring, after restoring the converged infrastructure configuration and mapping information, the backup information to the second converged infrastructure computer system.

3. The method of claim 2, wherein the storing and restoring functions are performed automatically by the back appliance without human intervention during the functions.

4. The method of claim 2, wherein the converged infrastructure computer platform include a plurality of computer blades.

5. The method of claim 2, wherein the backup information includes software and data.

6. The method of claim 2, wherein the second converged infrastructure computer system is located in a location geographically remote from the first converged infrastructure computer.

7. The method of claim 6, wherein the backup appliance communicates with the second converged infrastructure computer over the Internet.

8. A backup computer comprising:
a memory including computer instructions stored therein;
a processor in communication with the memory where when computer instructions are executed by the processor, they cause the processor to perform the following steps:
receive and store converged infrastructure configuration and mapping information for a first converged infrastructure computer platform where the converged infrastructure configuration and mapping information define a configuration of the first converged infrastructure computer system at a particular point in time;
receive and store backup information from the first converged infrastructure computer platform; and
associate the configuration with the backup information received from the first converged infrastructure computer platform.

9. The backup computer of claim 8, where the processor further performs the following steps:
restore the converged infrastructure configuration and mapping information to a second converged infrastructure computer system; and
restore, after restoring the converged infrastructure configuration and mapping information, the backup information to the second converged infrastructure computer system.

10. The method of claim 9, wherein the store and restore functions are performed automatically by the back appliance without human intervention during the functions.

11. The method of claim 8, wherein the converged infrastructure computer platform include a plurality of computer blades.

12. The method of claim 8, wherein the backup information includes software and data.

13. The method of claim 8, wherein the second converged infrastructure computer system is located in a location geographically remote from the first converged infrastructure computer.

14. A computer system comprising:
a first converged infrastructure computer system;
a second converged infrastructure computer system; and
a backup computer including a processor in communication with the first and second converged infrastructure computer systems, the backup computer further including computer instructions that when executed by the processor cause the processor to perform the following steps:
receive and store converged infrastructure configuration and mapping information for the first converged infrastructure computer platform where the converged infrastructure configuration and mapping information define a configuration of the first converged infrastructure computer system at a particular point in time;
receive and store backup information from the first converged infrastructure computer platform; and
associate the configuration with the backup information received from the first converged infrastructure computer platform.

15. The system of claim 14, where the processor further performs the steps of:
restore the converged infrastructure configuration and mapping information to a second converged infrastructure computer system; and
restore, after restoring the converged infrastructure configuration and mapping information, the backup information to the second converged infrastructure computer system.

16. The system of claim 15, where the backup information includes software and data.

17. The system of claim 15, wherein the second converged infrastructure computer system is remotely located from the first converged infrastructure computer system.

18. The system of claim 15, wherein the backup computer communicates with a second backup computer in a second computer system wherein the second backup computer performs the restore steps.

19. The system of claim 15, wherein the store and restore functions are performed automatically by the back computer without human intervention during the functions.
